(19) United States
(12) Patent Application Publication
(10) Pub. No.: US 2011/0128673 A1
(43) Pub. Date: Jun. 2, 2011

(54) Chip-type electric double layer capacitor and method of manufacturing the same

(75) Inventors: Sang Kyun Lee, Suwon (KR); Chang Ryul Jung, Seoul (KR); Sung Ho Lee, Seongnam (KR); Dong Sup Park, Suwon (KR); Yeong Su Cho, Guri (KR)

(73) Assignee: SAMSUNG ELECTRO-MECHANICS CO., LTD., Suwon (KR)

(21) Appl. No.: 12/662,916

(22) Filed: May 11, 2010

(30) Foreign Application Priority Data
Dec. 1, 2009 (KR) 10-2009-0117643

(51) Int. Cl. H01G 9/016; H01G 9/155

(52) U.S. Cl. 361/502; 29/25.03

(57) ABSTRACT

There is provided a chip-type electric double layer capacitor including: an exterior case having a housing space provided therein and formed of insulation resin; first and second external terminals buried in the exterior case, each having a plurality of first surfaces exposed to the housing space and a second surface exposed to an outside of the exterior case; and an electric double layer cell electrically connected to the plurality of first surfaces of the first and second external terminals exposed to the housing space. The chip-type electric double layer capacitor may be reduced in size and weight and increased in capacity. Also, the chip-type electric double layer capacitor allows for surface mounting without any additional structure and has low equivalent series resistance (ESR).

### CROSS-REFERENCE TO RELATED APPLICATIONS

This application claims the priority of Korean Patent Application No. 10-2009-0117643 filed on Dec. 1, 2009, in the Korean Intellectual Property Office, the disclosure of which is incorporated herein by reference.

### BACKGROUND OF THE INVENTION

1. Field of the Invention

The present invention relates to a chip-type electric double layer capacitor and a method of manufacturing the same, and more particularly, to a chip-type electric double layer capacitor allowing for surface mounting without any additional structure and having high capacity and low contact resistance and a method of manufacturing the same.

2. Description of the Related Art

In various electronic products such as information communication devices, a stable energy supply is considered to be an important element. In general, such a function is performed by a capacitor. That is, the capacitor serves to store electricity in a circuit provided in various electronic products such as information communication devices and then discharge the electricity, thereby stabilizing the flow of electricity with the circuit. A general capacitor has a short charge and discharge time, a long lifespan, and high output density. However, since the general capacitor has low energy density, there is a limitation in using the capacitor as a storage device.

To overcome such a limitation, a new category of capacitors such as electric double layer capacitors have recently been developed, which have a short charge and discharge time and high output density. A great deal of attention is being paid to such capacitors as next generation energy devices together with secondary cells.

The electric double layer capacitor is an energy storage device using a pair of charge layers (electrode layers) having different polarities. The electric double layer capacitor may perform continuous electrical charge and discharge cycles and have higher energy efficiency and output and greater durability and stability than other, more general capacitors. Accordingly, the electric double layer capacitor which may be charged and discharged with high current is being recognized as a storage device which may be charged and discharged at a high frequency, such as an auxiliary power supply for mobile phones, an auxiliary power supply for electric vehicles, and an auxiliary power supply for solar cells.

A basic structure of the electric double layer capacitor includes an electrode, an electrolyte, a current collector, and a separator. The electrode has a relatively large surface area such as a porous electrode. The operational principle of the electric double layer capacitor is an electro-chemical mechanism in which electricity is generated when a voltage of several volts is applied to both ends of a unit cell electrode such that ions in the electrolyte move along an electric field to be adsorbed by an electrode surface.

In general, to surface mount such an electric double layer capacitor on a circuit board, a bracket is welded over and under the electric double layer capacitor, and the electric double layer capacitor is then mounted on the circuit board through the bracket.

However, the electric double layer capacitor having such a structure has a relatively large thickness. Due to the additional structures required for surface mounting, such as the brackets or the like, the thickness further increases. When such an electric double layer capacitor is used, there may be difficulties in manufacturing high-capacity products because of the increase in thickness. Furthermore, since an additional manufacturing process must be performed, the price of products inevitably increases.

Also, as an electric double layer capacitor becomes smaller, contact resistance increases. Accordingly, it is difficult to reduce equivalent series resistance (ESR) while high capacitance is maintained.

### SUMMARY OF THE INVENTION

An aspect of the present invention provides a chip-type electric double layer capacitor allowing for surface mounting without any additional structure and having high capacity and low contact resistance and a method of manufacturing the same.

According to an aspect of the present invention, there is provided a chip-type electric double layer capacitor including: an exterior case having a housing space provided therein and formed of insulation resin; first and second external terminals buried in the exterior case, each having a plurality of first surfaces exposed to the housing space and a second surface exposed to an outside of the exterior case; and an electric double layer cell electrically connected to the plurality of first surfaces of the first and second external terminals exposed to the housing space.

The first and second external terminals may include first and second terminal extension portions connecting the plurality of first surfaces to each other, respectively.

At least one of the first and second terminal extension portions may be buried in the exterior case.

The exterior case may be formed such that the insulation resin and the first and second external terminals are integrated by insert injection molding.

The first and second external terminals may be formed on the same surface of the exterior case.

The exterior case may include a lower case having the housing space of which a top surface is opened and the first and second external terminals buried therein, and an upper cap mounted on the lower case so as to cover the housing space.

The insulation resin may be polyphenylene sulfide (PPS) or liquid crystal polymer (LCP).

The electric double layer capacitor cell may include first and second current collectors, first and second electrodes disposed on the first and second current collectors, respectively, and an ion-permeable separator disposed between the first and second electrodes.

The first and second current collectors may include first and second lead portions connected to the plurality of first surfaces of the first and second external terminals, respectively.

According to another aspect of the present invention, there is provided a method of manufacturing a chip-type electric double layer capacitor, the method including: forming a lower case having an opened housing space, formed of insulation resin, and having first and second external terminals buried therein, each of the first and second external terminals having a plurality of first surfaces exposed to the housing space and a second surface exposed to an outside of the lower case; mounting an electric double layer capacitor cell in the housing space such that the electric double layer capacitor cell is electrically connected to the plurality of first surfaces of the first and second external terminals; and mounting an upper cap on the lower case so as to cover the housing space.

The forming of the lower case may be performed by insert injection molding.

The connection between the first and second external terminals and the electric double layer capacitor cell may be performed by welding or ultrasonic welding.

The mounting of the upper cap on the lower case may be performed by welding or ultrasonic welding.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating a chip-type electric double layer capacitor according to an exemplary embodiment of the present invention;

FIG. 2 is a schematic cross-sectional view illustrating the chip-type electric double layer capacitor of FIG. 1, taken along line I-I′;

FIG. 3A is a schematic plan view illustrating one surface of an exterior case having first and second external terminals buried therein in a chip-type electric double layer capacitor according to an exemplary embodiment of the present invention;

FIG. 3B is a schematic plan view illustrating one surface of an exterior case having first and second external terminals buried therein in a chip-type electric double layer capacitor according to another exemplary embodiment of the present invention;

FIG. 4 is a schematic perspective view illustrating first and second external terminals according to an exemplary embodiment of the present invention;

FIG. 5 is a schematic cross-sectional view illustrating one surface of an exterior case having first and second external terminals buried therein in the chip-type electric double layer capacitor of FIG. 3A, taken along line I-I′;

FIG. 6 is a schematic exploded perspective view illustrating a chip-type electric double layer capacitor according to an exemplary embodiment of the present invention; and

FIGS. 7A through 7C are cross-sectional views illustrating a method of manufacturing a chip-type electric double layer capacitor according to an exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as limited to the embodiments set forth herein. Rather, these embodiments are provided so that this disclosure will be thorough and complete, and will fully convey the scope of the invention to those skilled in the art. It should be considered that the shapes and dimensions of elements in the drawings may be exaggerated for clarity. Throughout the drawings, the same reference numerals will be used to designate the same or like elements.

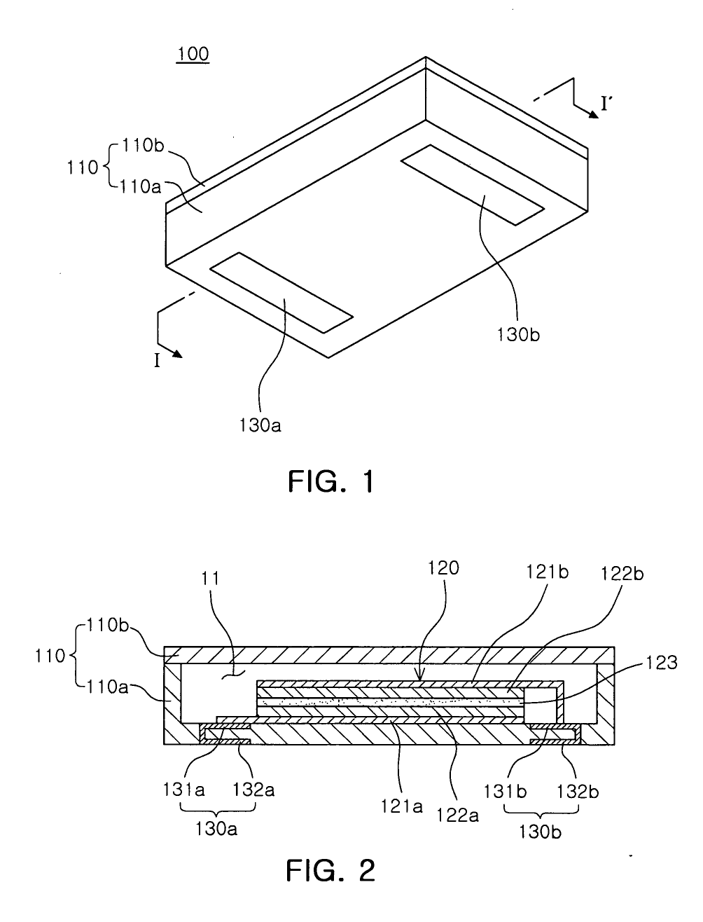

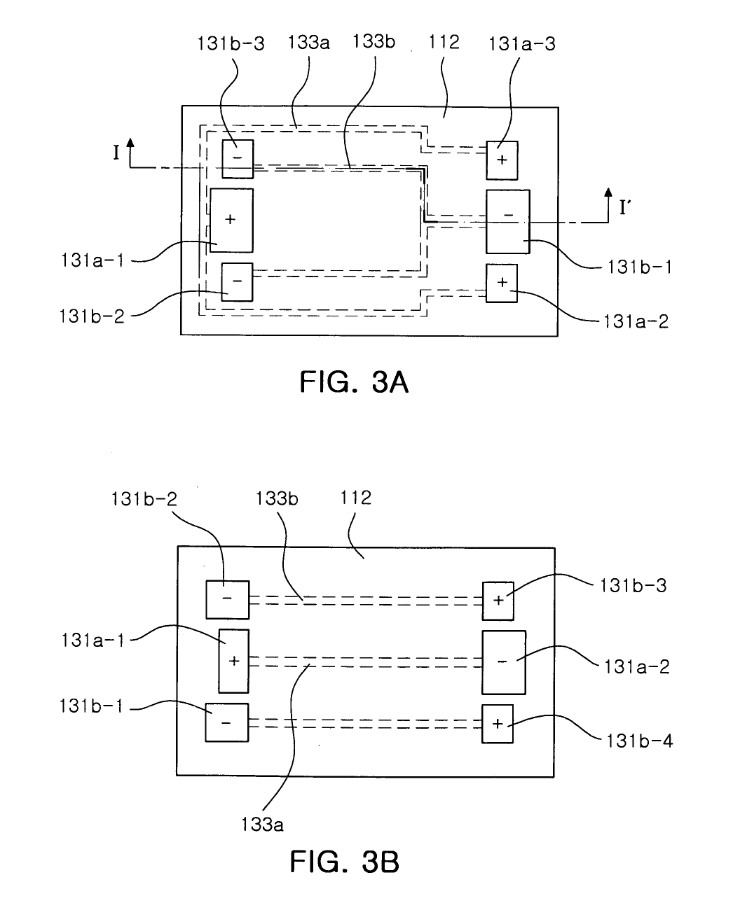

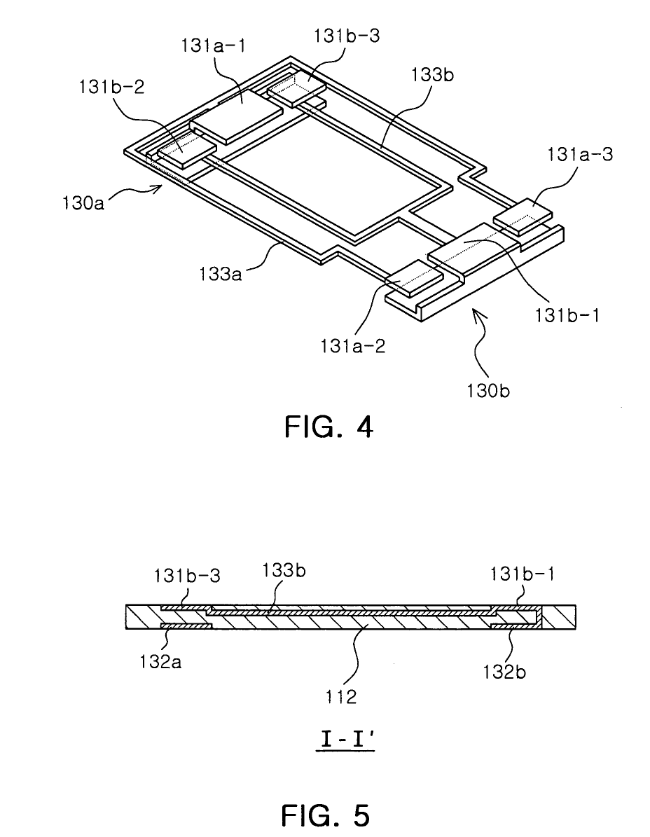

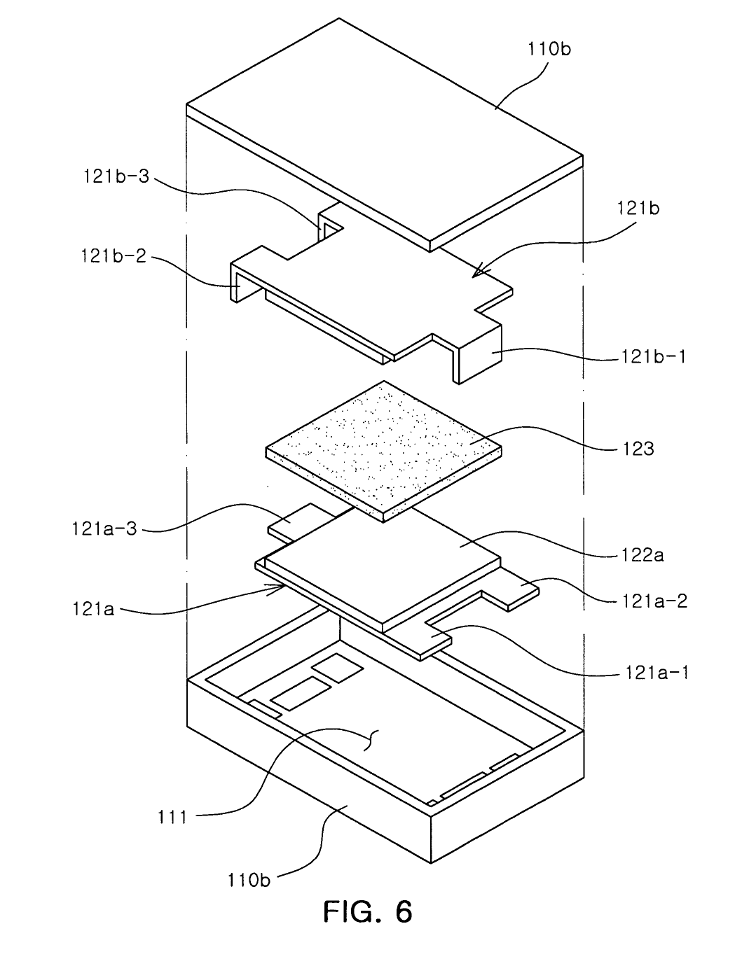

FIG. 1 is a schematic perspective view illustrating a chip-type electric double layer capacitor according to an exemplary embodiment of the present invention. FIG. 2 is a schematic cross-sectional view illustrating the chip-type electric double layer capacitor of FIG. 1, taken along a line I-I′. FIG. 3A is a schematic plan view illustrating one surface of an exterior case having first and second external terminals buried therein in a chip-type electric double layer capacitor according to an exemplary embodiment of the present invention. FIG. 4 is a schematic perspective view illustrating first and second external terminals according to an exemplary embodiment of the present invention. FIG. 5 is a schematic cross-sectional view illustrating one surface of an exterior case having first and second external terminals buried therein in the chip-type electric double layer capacitor of FIG. 3A, taken along a line I-I′ FIG. 6 is a schematic exploded perspective view illustrating a chip-type electric double layer capacitor according to an exemplary embodiment of the present invention.

Referring to FIGS. 1 and 2, a chip-type electric double layer capacitor 100 according to this embodiment includes an exterior case 110 having a housing space 111 formed therein and formed of insulation resin, and an electric double layer capacitor cell 120 disposed in the housing space 111 of the exterior case 110.

The exterior case 110 includes first and second external terminals 130a and 130b buried in one surface thereof. The first external terminal 130a has a first surface 131a exposed to the housing space 111 and a second surface 132a exposed to the outside of the exterior case 110, and the second external terminal 130b has a first surface 131b exposed to the housing space 111 and a second surface 132b exposed to the outside of the exterior case 110. That is, the first and second external terminals 130a and 130b are structures for connecting the outside of the exterior case 110 and the housing space 111 of the exterior case 110.

The electric double layer capacitor cell 120 is electrically connected to the first surfaces 131a and 131b of the first and second external terminals 130a and 130b exposed to the housing space 111.

Referring to FIGS. 3A, 4 and 5, the first external terminal 130a according to this embodiment includes the first surface 131a exposed to the housing space 111 of the exterior case 110. The first surface 131a may include three first surfaces 131a-1, 131a-2, and 131a-3 that are spaced apart from each other. The second external terminal 130b according to this embodiment includes the first surface 131b exposed to the housing space 111 of the exterior case 110. The first surface 131b may include three first surfaces 131b-1, 131b-2, and 131b-3 that are spaced apart from each other.

The three first surfaces 131a-1, 131a-2, and 131a-3 may be connected to each other by a first terminal extension portion 133a.

The primary first surface 131a-1 of the first external terminal 130a is directly connected to the second surface 132a of the first external terminal 130a, and the secondary and tertiary first surfaces 131a-2 and 131a-3 thereof are connected to the primary first surface 131a-1 by the first terminal extension portion 133a to thereby be connected to the second surface 132a of the first external terminal 130a. The first terminal extension portion 133a of the first external terminal 130a may be disposed to have an appropriate shape in order to prevent a short circuit with the second external terminal 130b. In this embodiment, the first terminal extension portion 133a has a bent shape.

The three first surfaces 131b-1, 131b-2, and 131b-3 of the second external terminal 130b also have a similar structure.

As shown in FIG. 5, a second terminal extension portion 133b is buried in an exterior case in order to prevent a short circuit.

More specifically, the first terminal extension portion 133a of the first external terminal 130a connected to a first current collector of the electric double layer capacitor cell 120 may not be buried in the exterior case, whereas the second terminal extension portion 133b of the second external terminal 130b connected to a second current collector may be buried in the exterior case.

Otherwise, both of the first and second terminal extension portions 133a and 133b of the first and second external terminals 130a and 130b may be buried in the exterior case.

The position of each of the three first surfaces 131a-1, 131a-2, and 131a-3 is not particularly limited as long as it can be connected to the electric double layer capacitor cell 120. Also, the shape of the first and second terminal extension portions 133a and 133b is not particularly limited as long as it allows for the connection of a plurality of first surfaces included in the first and second external terminals 130a and 130b.

FIG. 3B is a schematic plan view illustrating one surface 112 of an exterior case, in which first and second external terminals are buried, in a chip-type electric double layer capacitor according to another exemplary embodiment of the present invention.

Referring to FIG. 3B, the first external terminal 130a according to this embodiment has the first surface 131a exposed to the housing space 111 of the exterior case 110 and including two first surfaces 131a-1 and 131a-2. The second external terminal 130b according to this embodiment includes the first surface 131b exposed to the housing space 111 of the exterior case 110 and including four first surfaces 131b-1, 131b-2, 131b-3, and 131b-4.

The two first surfaces 131a-1 and 131a-2 of the first external terminal 130a are connected by the first terminal extension portion 133a having a straight shape.

The four first surfaces 131b-1, 131b-2, 131b-3 and 131b-4 of the second external terminal 130b are also connected by the second terminal extension portion 133b having a straight shape.

The first surfaces 131a and 131b of the first and second external terminals 130a and 130b are provided as areas contacting the electric double layer capacitor cell 120. The first surfaces 131a and 131b may include a plurality of first surfaces that are connected by the first and second terminal extension portions 133a and 133b, respectively. In this manner, the contact areas between the external terminals and the electric double layer capacitor cell may be varied, and current supply areas may be expanded.

Therefore, the electric double layer capacitor according to this embodiment may reduce equivalent series resistance (ESR) without a reduction of electrostatic capacity.

The second surfaces 132a and 132b of the first and second external terminals 130a and 130b exposed to the outside of the exterior case 110 may be used to electrically connect the electric double layer capacitor cell 120 to an external power source.

The first and second external terminals 130a and 130b may be formed integrally with the exterior case 110 by insert injection molding or the like, and accordingly, the first and second external terminals 130a and 130b may be buried in the exterior case 110.

As illustrated, the first and second external terminals 130a and 130b may be buried in the same surface 112 of the exterior case 110. When the first and second external terminals 130a and 130b are buried in the same surface 112, the chip-type electric double layer capacitor 100 itself may be surface-mounted using surface-mount technology (SMT) without any additional structure. In order to implement such a structure, the first and second external terminals 130a and 130b and the exterior case 110 may form a single plane.

Hereinafter, the connection between the electric double layer capacitor cell 120 and the first surfaces 131a and 131b of the first and second external terminals 130a and 130b exposed to the housing space 111 will be described in more detail.

Referring to FIGS. 2 and 6, the electric double layer capacitor cell 120 includes first and second current collectors 121a and 121b, first and second electrodes 122a and 122b respectively formed on the first and second current collectors 121a and 121b, and an ion-permeable separator 123 formed between the first and second electrodes 122a and 122b.

The first and second current collectors 121a and 121b are conductive sheets for transferring an electrical signal to the first and second electrodes 122a and 122b, respectively, and may be formed of a conductive polymer, a rubber sheet, or a metallic foil. In this embodiment, the electric double layer capacitor cell 120 is electrically connected to the first and second external terminals 130a and 130b through the first and second current collectors 121a and 121b. More specifically, the first and second current collectors 121a and 121b are connected to the plurality of first surfaces 131a and 131b of the first and second external terminals 130a and 130b.

The shapes of the first and second current collectors 121a and 121b may be properly modified in such a manner that they are electrically connected to the first and second external terminals 130a and 130b, respectively. Such a modification may be influenced by the positions of the plurality of first surfaces 131a and 131b of the first and second external terminals 130a and 130b. The second current collector 121b disposed at the upper portion of the electric double layer capacitor cell 120 may have a partially bent shape.

As shown in FIG. 6, the first current collector 121a has a first lead portion where an electrode material is not formed. The first lead portion is connected to the plurality of first surfaces 131a of the first external terminal 130a.

In this embodiment, the first current collector 121a includes three first lead portions 121a-1, 121a-2, and 121a-3 that are connected to the first surfaces 131a-1, 131a-2, and 131a-3 of the first external terminal 130a.

The second current collector 121b includes three second lead portions 121b-1, 121b-2, and 121b-3 that are bent and connected to the first surfaces 131b-1, 131b-2, and 131b-3 of the second external terminal 130b.

The first and second lead portions and the first surfaces 131a and 131b of the first and second external terminals 130a and 130b may be connected by welding or ultrasonic welding.

The first and second electrodes 122a and 122b may be formed of a polarizable electrode material. For example, activated carbon with a relatively high specific surface area may be used. The first and second electrodes 122a and 122b may be manufactured by making an electrode material mainly consisting of powdered activated carbon into a solid-state sheet or adhering electrode material slurry onto the first and second current collectors 121a and 121b.

Although not shown, when the electric double layer capacitor cell 120 does not include the first and second current collectors 121a and 121b, the first and second electrodes 122a and 122b may be connected to the plurality of first surfaces of the first and second external terminals 130a and 130b exposed to the housing space 111.

The ion-permeable separator 123 may be formed of a porous material through which ions can permeate. For example, a porous material such as polypropylene, polyethylene, or glass fiber may be used. However, the material is not limited thereto.

In FIGS. 2 and 6, the electric double layer capacitor may be formed by continuously stacking unit cells, each of which includes the first and second current collectors 121a and 121b, the first and second electrodes 122a and 122b, and the ion-permeable separator 123.

The electric double layer capacitor according to this embodiment has high space utilization efficiency. Even when it includes the electric double layer capacitor cell having a multilayer structure, it can be miniaturized.

In this embodiment, the exterior case 110 may include a lower case 110a having the housing space 111 of which the top surface is opened and the first and second external terminals 130a and 130b buried therein, and an upper cap 110b mounted on the lower case 110a so as to cover the housing space 111.

The lower case 110a and the upper cap 110b may be coupled to each other by welding or ultrasonic welding.

The exterior case 110 is formed of insulation resin. Examples of the insulation resin may include polyphenylene sulfide (PPS) or liquid crystal polymer (LCP). Accordingly, the chip-type electric double layer capacitor 100 may protect its internal structure during the surface mounting (SMT) process which is performed at a high temperature of about 240° C. to 270° C.

As described above, the chip-type electric double layer capacitor according to this embodiment has such a structure that the first and second external terminals 130a and 130b are buried in the exterior case 110. Therefore, its space utilization efficiency increases. Accordingly, it is possible to increase the stacking degree of the electric double layer capacitor cell mounted in the chip-type electric double layer capacitor.

Also, the chip-type electric double layer capacitor according to this embodiment may allow for a reduction of ESR without a reduction of electrostatic capacity.

Hereinafter, a method of manufacturing a chip-type electric double layer capacitor according to an exemplary embodiment of the present invention will be described in detail with reference to the accompanying drawings.

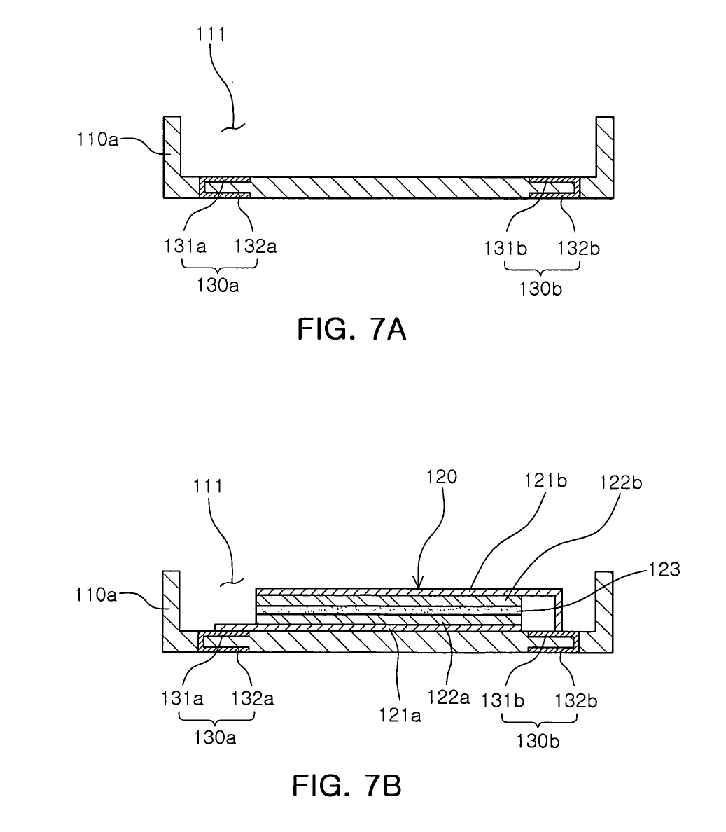

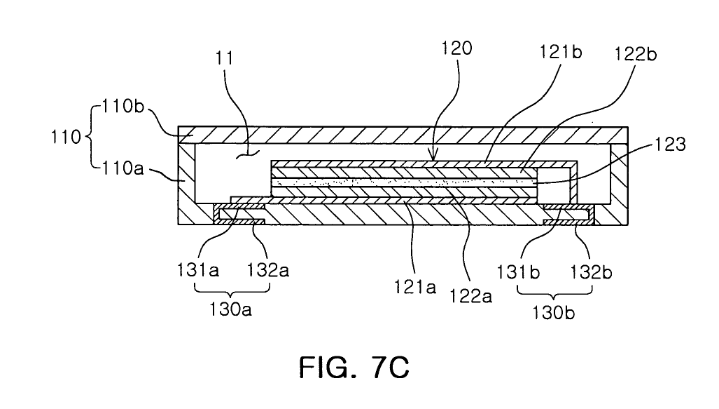

FIGS. 7A through 7C are cross-sectional views illustrating a method of manufacturing a chip-type electric double layer capacitor according to an exemplary embodiment of the present invention.

First, as shown in FIG. 7A, the lower case 110a is formed such that the lower case 110a has the opened housing space 111, is formed of insulation resin, and includes the first and second external terminals 130a and 130b buried therein. The first external terminal 130a has the plurality of first surfaces 131a exposed to the housing space 111 and the second surface 132a exposed to the outside of the lower case 110a. The second external terminal 130b has the plurality of first surfaces 131b exposed to the housing space 111 and the second surface 132b exposed to the outside of the lower case 110a.

The process of forming the lower case 110a is not specifically limited, as long as the insulation resin and the first and second external terminals 130a and 130b may be integrally molded so that the first and second external terminals 130a and 130b are buried in the insulation resin. For example, insert injection molding may be applied.

More specifically, the first and second external terminals 130a and 130b are disposed in a mold having a desired lower-case shape, and the insulation resin is injected into the mold. The insulation resin injected into the mold hardens with the first and second external terminals 130a and 130b in the mold through cooling or cross-linking. The insulation resin and the first and second external terminals 130a and 130b are integrated by the insert injection molding, even though the first and second external terminals 130a and 130b are formed of a different material from the insulation resin.

At this time, the first and second external terminals 130a and 130b may employ those shown in FIG. 4. The first external terminal 130a includes the second surface 132a and the first surface 131a connected to the second surface 132a, and the second external terminal 130b includes the second surface 132b and the first surface 131b connected to the second surface 132b. The first surfaces 131a and 131b include a plurality of first surfaces.

Next, as shown in FIG. 7B, the electric double layer capacitor cell 120 is mounted in the housing space 111 so as to be electrically connected to the plurality of first surfaces 131a and 131b of the first and second external terminals 130a and 130b exposed to the housing space 111 of the lower case 110a.

The electric double layer capacitor cell 120 may include the first and second current collectors 121a and 121b, the first and second electrodes 122a and 122b formed on the first and second current collectors 121a and 121b, respectively, and the ion-permeable separator 123 formed between the first and second electrodes 122a and 122b.

The first and second current collectors 121a and 121b are electrically connected to the plurality of first surfaces 131a and 131b of the first and second external terminals 130a and 130b exposed to the housing space 111.

As described above, the first and second current collectors 121a and 121b have lead portions where an electrode material is not formed. The lead portions are connected to the plurality of first surfaces 131a and 131b of the first and second external terminals 130a and 130b.

The first and second external terminals 130a and 130b may be connected to the first and second current collectors 121a and 121b, respectively, by welding or ultrasonic welding. For example, resistance welding or arc welding may be applied. However, the connecting method is not limited thereto.

The lower case 110a having the electric double layer capacitor cell 120 mounted therein is filled with an electrolyte. In this case, an aqueous electrolyte or non-aqueous electrolyte may be used as the electrolyte.

Then, as shown in FIG. 7C, the upper cap 110b is mounted on the lower case 110a so as to cover the housing space 111.

The mounting of the upper cap 110b on the lower case 110a may be performed by welding or ultrasonic welding. The mounting method is not limited thereto. For example, resistance welding or arc welding may be applied. Through such a process, the airtightness between the lower case 110a and the upper cap 110b may be improved to protect the internal elements of the exterior case.

As set forth above, according to exemplary embodiments of the invention, the chip-type electric double layer capacitor has the exterior case and the external terminals integrally formed, thereby allowing for high space utilization. Accordingly, the electric double layer capacitor may be reduced in size and weight and increased in capacity.

Furthermore, the chip-type electric double layer capacitor may be surface-mounted without any additional structure. A collective mounting technique using a solder method may be applied to simplify the surface mounting process.

In addition, since the contact areas between the external terminals and the electric double layer capacitor cell may be varied, current supply areas may be expanded. Accordingly, the ESR may be reduced without a reduction of capacity.

While the present invention has been shown and described in connection with the exemplary embodiments, it will be apparent to those skilled in the art that modifications and variations can be made without departing from the spirit and scope of the invention as defined by the appended claims.

What is claimed is:

1. A chip-type electric double layer capacitor comprising:
an exterior case having a housing space provided therein and formed of insulation resin;
first and second external terminals buried in the exterior case, each having a plurality of first surfaces exposed to the housing space and a second surface exposed to an outside of the exterior case; and
an electric double layer cell electrically connected to the plurality of first surfaces of the first and second external terminals exposed to the housing space.

2. The chip-type electric double layer capacitor of claim 1, wherein the first and second external terminals comprise first and second terminal extension portions connecting the plurality of first surfaces to each other, respectively.

3. The chip-type electric double layer capacitor of claim 2, wherein at least one of the first and second terminal extension portions is buried in the exterior case.

4. The chip-type electric double layer capacitor of claim 1, wherein the exterior case is formed such that the insulation resin and the first and second external terminals are integrated by insert injection molding.

5. The chip-type electric double layer capacitor of claim 1, wherein the first and second external terminals are formed on the same surface of the exterior case.

6. The chip-type electric double layer capacitor of claim 1, wherein the exterior case comprises:
a lower case having the housing space of which a top surface is opened and the first and second external terminals buried therein; and
an upper cap mounted on the lower case so as to cover the housing space.

7. The chip-type electric double layer capacitor of claim 1, wherein the insulation resin is polyphenylene sulfide (PPS) or liquid crystal polymer (LCP).

8. The chip-type electric double layer capacitor of claim 1, wherein the electric double layer capacitor cell comprises:
first and second current collectors;
first and second electrodes disposed on the first and second current collectors, respectively; and
an ion-permeable separator disposed between the first and second electrodes.

9. The chip-type electric double layer capacitor of claim 8, wherein the first and second current collectors comprise first and second lead portions connected to the plurality of first surfaces of the first and second external terminals, respectively.

10. A method of manufacturing a chip-type electric double layer capacitor, the method comprising:
forming a lower case having an opened housing space, formed of insulation resin, and having first and second external terminals buried therein, each of the first and second external terminals having a plurality of first surfaces exposed to the housing space and a second surface exposed to an outside of the lower case;
mounting an electric double layer capacitor cell in the housing space such that the electric double layer capacitor cell is electrically connected to the plurality of first surfaces of the first and second external terminals; and
mounting an upper cap on the lower case so as to cover the housing space.

11. The method of claim 10, wherein the forming of the lower case is performed by insert injection molding.

12. The method of claim 10, wherein the connection between the first and second external terminals and the electric double layer capacitor cell is performed by welding or ultrasonic welding.

13. The method of claim 10, wherein the mounting of the upper cap on the lower case is performed by welding or ultrasonic welding.
